(19) United States
(12) Patent Application Publication
(10) Pub. No.: US 2026/0322258 A1
(43) Pub. Date: Oct. 15, 2026

(54) RESONANT POWER CONVERTER AND CONTROLLED CAPACITOR DISCHARGE

(71) Applicant: Infineon Technologies Austria AG, Villach (AT)

(72) Inventors: Alfredo Medina-Garcia, Muenchen (DE); Tiam Poh Lau, Ottobrunn (DE); Shi-Heng Hong, New Taipei City (TW)

(21) Appl. No.: 19/174,394

(22) Filed: Apr. 9, 2025

(51) Int. Cl. H02M 3/00; H02M 1/00

(52) U.S. Cl. CPC H02M 3/01; H02M 1/0032; H02M 1/0058

(57) ABSTRACT

A controller may be configured to: control multiple switches in a resonant power converter during a first operational mode and implement a second operational mode of discontinued switching of the multiple switches ON and OFF. In a first example, based on a time duration associated with operation of the resonant power converter, the controller can be configured to control the multiple switches in the resonant power converter to discharge a resonant capacitor of the resonant power converter. In a second example, during the second operational mode, the controller can be configured to control the first switch to discharge a resonant capacitor of the resonant power converter. In a third example, based on a monitored magnitude of current through a first switch of the multiple switches, the controller can be configured to control the first switch of the multiple switches to discharge a resonant capacitor of the resonant power converter.

### TECHNICAL FIELD

The present application relates to controllers such as associated with resonant power converters, and resonant power converters including such controllers and corresponding methods of operating such resonant power converters.

### BACKGROUND

Power converters are used in many applications to convert an input electrical power to an output electrical power, which is appropriate for a respective appliance or device with respect to voltage, current, or both. For example, charger devices for smartphones or tablets or power supplies for computers, laptops, and a plurality of other devices convert an input power, typically a mains power, to an appropriate output power (voltage and current). For instance, the mains power typically is an AC (alternating current) power with a voltage ranging between 100 volt and 300 volt depending on country, and output voltages required may be in a range from 3 volt to 20 volt DC (direct current), depending on application.

Sometimes, conventional power converters include a plurality of stages, for example a so called power factor correction stage providing an intermediate voltage, also referred to as bus voltage, and a second stage performing the actual regulation to a desired output voltage.

One type of power converters are resonant power converters, where during operation typically in a first phase power is provided to a resonant circuit including a capacitor (referred to as resonant capacitor herein) and at least one inductor, and in a second phase power is provided to an output side of the resonant converter. On the output side, the output signal is typically provided via an output capacitor. Examples for such resonant converters include active clamp flyback (ACF) converters or asymmetric half-bridge flyback (AHBF) converters.

### BRIEF DESCRIPTION

This disclosure includes the observation that, under some conditions, a conventional power converter may be required to or may be forced to cease operation. Such conditions will be referred to as exception conditions herein and may include for example a disconnect from the input voltage like mains voltage (intentional or due to a power outage), turning off of a device including the power converter, overcurrent conditions, short circuit conditions and the like. In such an exception condition, in conventional solutions, so called primary side switches, for example a high side switch and a low side switch provided in a half-bridge configuration, are switched off to prevent an overvoltage or overcurrent condition on the output. When restarting the power converter, remaining charges may lead to unwanted current surges. An example of the conventional resonant power converter shown in FIG. 1.

As previously discussed, a conventional hybrid flyback power converter can be configured to include a resonant capacitor in the primary side, where the resonant capacitor is effectively connected through the transformer to the output capacitor in the secondary side during operation for energy transfer. This disclosure further includes the observation that the corresponding resonant capacitor in the primary side is susceptible to damage. For example, during certain circumstances, the output capacitor in the secondary side is discharged while the converter is not switching but the primary side capacitor Cr remains charged. In general, when the resonant power converter switches between operational modes, there is effectively a low ohmic path connecting the two capacitors (such as capacitor CR to capacitor Cout), which potentially leads to high current that may destroy the switches of the converter, particularly the low side switch in the example of FIG. 1.

Examples herein provide novel and improved operation of a respective resonant power converter.

More specifically, in one example, an apparatus (such as a resonant power converter, hybrid flyback converter, etc.) or other suitable entity includes a controller. The controller can be configured to (a.k.a., operative to): control ON/OFF settings of multiple switches in a resonant power converter during a first operational mode to convert an input voltage into an output voltage; in response to first feedback, implement a second operational mode of discontinued switching of the multiple switches ON and OFF; and based on a time duration associated with operation of the resonant power converter, control the multiple switches in the resonant power converter to discharge a resonant capacitor of the resonant power converter.

In a further example, the time duration is a measurement of the implemented second operational mode of discontinued switching of the multiple switches.

In another example, the multiple switches in the resonant power converter include a first switch and a second switch disposed in series; and the controller is further configured to: derive a metric for controlling the first switch based on the time duration. The metric may indicate timing associated with activating the first switch to discharge the resonant capacitor of the resonant power converter. For example, the metric may indicate a number of pulses of activating the first switch to cause the discharge the resonant capacitor. The magnitude of the metric for controlling the first switch may be proportional to a magnitude of the time duration.

In yet another example, the multiple switches include a first switch and a second switch, the first switch disposed in series with the resonant capacitor. The controller can be configured to: while the second switch is controlled to an OFF-state during the discharge of the resonant capacitor, control switching operation of the first switch to discharge the resonant capacitor prior to controlling the power converter in the first operational mode again.

Further examples as discussed herein include a controller configured to: measure the time duration of the discontinued switching of the multiple switches while in the second operational mode; based on the measured time duration, control timing of activating and deactivating a first switch of the multiple switches to discharge the resonant capacitor; and wherein a cumulative ON-time associated with the controlled timing of the first switch to discharge the resonant capacitor is based on the measured time duration.

In still further examples as discussed herein, the controller is configured to: control the multiple switches in the resonant power converter to discharge the resonant capacitor in response to receiving second feedback, where the second feedback indicates that the magnitude of the output voltage is less than a setpoint reference voltage.

In further examples, the multiple switches include a first switch and a second switch disposed in a first series circuit path, where the first series circuit path of multiple switches is configured to control conveyance of current received from the input voltage to the resonant capacitor; the resonant power converter further can be configured to include a primary winding disposed in series with the resonant capacitor in a second series circuit path; the second series circuit path may be disposed in parallel with the second switch; and the primary winding may be magnetically coupled to a secondary winding operative to produce the output voltage.

In another example as discussed herein, an apparatus (such as a resonant power converter, hybrid flyback converter, etc.) or other suitable entity includes a controller. The controller can be configured to (a.k.a., operative to): control multiple switches in a resonant power converter during a first operational mode to convert an input voltage into an output voltage; in response to first feedback, implement a second operational mode of controlling the multiple switches, the multiple switches including a first switch and a second switch; and during the second operational mode, controlling the second switch to an OFF state while controlling operation of the first switch between an OFF state and an ON state to discharge a resonant capacitor of the resonant power converter.

In one example, the first feedback indicates that the magnitude of the output voltage is greater than a threshold level. The controller can be further configured to, subsequent to the second operational mode, resume operation of the resonant power converter in the first operational mode in response to receiving second feedback. The second feedback may indicate that the output voltage is less than a threshold level (such as a setpoint reference voltage). In such an instance, the controller can be configured to switch over operation of the resonant power converter from the first operational mode to the second operational mode in response to detecting that a magnitude of the output voltage is greater than a threshold level. The controller can be configured to switch over operation of the resonant power converter from the second operational mode to the first operational mode in response to detecting that a magnitude of the output voltage is less than the threshold level.

In another example, operation of the resonant power converter in the second operational mode maintains a magnitude of a first voltage across the resonant capacitor with respect to a magnitude of the output voltage.

Still further, in another example, the controller can be configured to, subsequent to the second operational mode, resume the first operational mode of switching the multiple switches between the ON/OFF states to convert the input voltage into the output voltage.

As previously discussed, the multiple switches can be configured to include a first switch and a second switch disposed in a first series circuit path, where the first series circuit path is configured to control conveyance of current received from an input voltage. The resonant power further can be configured to include a transformer, where the transformer includes a primary winding and a secondary winding magnetically coupled to the primary winding. The primary winding may be disposed in series with the resonant capacitor and the second series circuit path. The second series circuit path may be disposed in parallel with the second switch. Flow of current through the primary winding causes a respective flow of current through the secondary winding, where the flow of current to the secondary winding produces the output voltage.

In yet another example as discussed herein, an apparatus (such as a resonant power converter, hybrid flyback converter, etc.) or other suitable entity includes a controller. The controller can be configured to: control multiple switches in a resonant power converter between ON/OFF states during a first operational mode to convert an input voltage into an output voltage; and in response to first feedback, implement a second operational mode of discontinued switching of the multiple switches ON and OFF; and based on a magnitude of current through a first switch of the multiple switches, control the first switch of the multiple switches to discharge a resonant capacitor of the resonant power converter.

In one example, the first switch is disposed in a series circuit loop; the series circuit loop can be configured to include a combination of the first switch, a primary winding of a transformer, and the resonant capacitor.

In another example, the controller can be configured to, subsequent to implementing the second operational mode, control the first switch to discharge the resonant capacitor prior to resuming the first operational mode of switching the multiple switches between the ON/OFF states.

In accordance with still further examples as discussed herein, the multiple switches can be configured to include a second, where the first switch is disposed in series with the second switch. The control of the first switch to discharge the resonant capacitor by the controller includes deactivation of the second switch to an OFF-state while the first switch is switched between an ON-state and an OFF-state.

Still further examples herein include the controller being configured to: while a second switch of the multiple switches is deactivated to an OFF-state: monitor a magnitude of the current through the first switch; compare the magnitude of current to a current threshold level; and switch the first switch between an ON-state and an OFF-state until the magnitude of the current through the first switch falls below the current threshold level. The controller can be configured to resume the first operational mode of switching the multiple switches ON and OFF in response to detecting that the magnitude of the current crosses the current threshold level.

Yet further examples herein include a controller configured to: control the first switch of the multiple switches to discharge the resonant capacitor in response to receiving second feedback indicating that the magnitude of the output voltage falls below a voltage threshold level.

As previously discussed, the multiple switches can be configured to include a first switch and a second switch disposed in a first series circuit path, where the first series circuit path is configured to control conveyance of current received from an input voltage. The resonant power further can be configured to include a transformer, where the transformer includes a primary winding and a secondary winding magnetically coupled to the primary winding. The primary winding may be disposed in series with the resonant capacitor and the second series circuit path. The second series circuit path may be disposed in parallel with the second switch. Flow of current through the primary winding causes a respective flow of current through the secondary winding, where the flow of current to the secondary winding produces the output voltage.

The magnitude of current may be a peak magnitude of the current to the first switch.

In another example, the magnitude of the current may be measured based upon a voltage across a resistor disposed in series with the resonant capacitor, wherein the voltage is proportional to the magnitude of the current.

These and other more specific examples are disclosed in more detail below.

Note further that although examples as discussed herein are applicable to fabrication of circuit assemblies such as power converter assemblies, the concepts disclosed herein may be advantageously applied to any other suitable topologies.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram of a power converter circuit implementing one or more novel control techniques to convert an input voltage into an output voltage as discussed herein.

FIG. 2 is an example timing diagram illustrating generation of control signals in accordance with zero-crossing detection as discussed herein.

FIG. 3 is an example diagram illustrating possible effects associated with operating the power converter as discussed herein.

FIG. 4 is an example diagram illustrating possible effects associated with operating the power converter as discussed herein.

FIG. 5A and FIG. 5B are example timing diagrams illustrating implementation of multiple control pulses to discharge energy stored in a resonant capacitor as discussed herein.

FIG. 6 is an example timing diagram illustrating implementation of multiple switch control pulses to discharge energy stored in a resonant capacitor as discussed herein.

FIG. 7 is an example circuit diagram illustrating inclusion of a supplemental resistor in a resonant power converter to monitor the magnitude of current through a resonant capacitor and winding as discussed.

FIG. 8 is an example diagram illustrating implementation of multiple switch control pulses to discharge energy stored in a resonant capacitor as discussed herein.

FIG. 9 is an example diagram illustrating implementation of a resonant power converter as discussed herein.

FIG. 10 is an example diagram illustrating a first method of implementing multiple switch control pulses to discharge energy stored in a resonant capacitor as discussed herein.

FIG. 11 is an example diagram illustrating a second method of implementing multiple switch control pulses to discharge energy stored in a resonant capacitor as discussed herein.

FIG. 12 is an example diagram illustrating a third method of implementing multiple switch control pulses to discharge energy stored in a resonant capacitor as discussed herein.

The foregoing and other objects, features, and advantages of examples herein will be apparent from the following more particular description herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

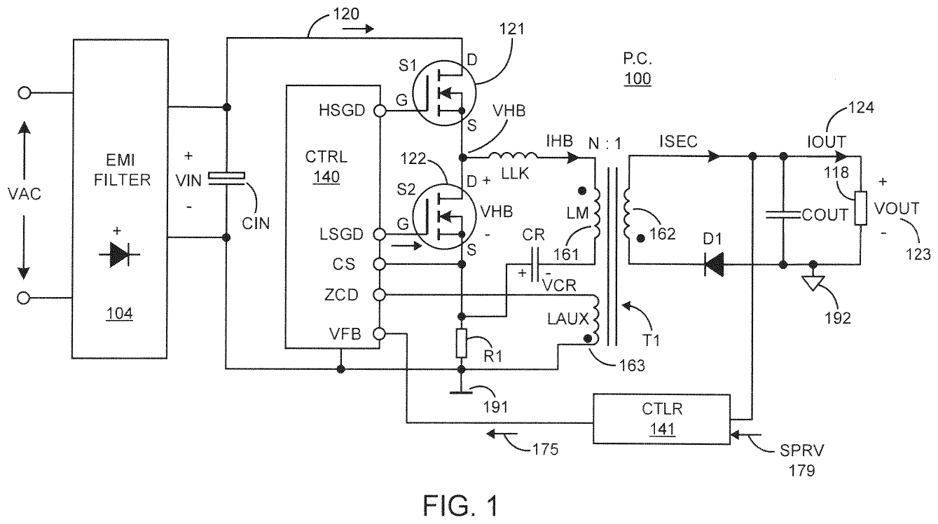

Now, more specifically, with reference to the drawings, FIG. 1 is an example diagram of a power converter circuit providing conversion of an input voltage into an output voltage as discussed herein.

As shown in FIG. 1, the power converter 100 (such as a resonant power converter) may be implemented as a so-called asymmetric half-bridge flyback power converter including controller 140. The power converter 100 further includes an EMI (Electro-Magnetic Interference) filter 104, input capacitor CIN, switch 121 (S1), switch 122 (S2), resistor R1, transformer T1, resonant capacitor CR, diode D1, feedback controller 141, and output capacitor Cout.

It is noted that the transformer T1 includes one or more windings such as primary winding 161, secondary winding 162, and auxiliary winding 163. Each of the windings is magnetically coupled to each other via a magnetic core of the transformer T1.

In general, during power conversion operation, the EMI filter 140 receives the alternating input voltage Vac and converts it into the input voltage 121 (a.k.a., Vin), which is generally a DC voltage stored in the input capacitor Cin.

As discussed herein, the controller 140 controls operation of the switches 121 and 122 to convert the input voltage 121 into the respective output voltage 123 outputted from the secondary winding 162. More specifically, control of the switches 121 and 122 controls a flow of the current Ihb through the primary winding 161 and the resonant capacitor Cr. The controlled flow of current Ihb through the primary winding 161 at appropriate times as discussed herein results in a corresponding flow of current Isec through the secondary winding 162, which produces the output voltage 123 powering the load 118.

In one respect, the transformer T1 provides galvanic isolation between a primary side and a secondary side associated with the power converter circuit 100. For example, the primary side controller 140 and corresponding circuitry such as primary winding 161 and auxiliary winding 163 and corresponding circuitry to the left of transformer T1 is referenced with respect to the ground reference 191.

The secondary winding 162 and corresponding circuitry to the right of the transformer T1 is referenced with respect to the ground reference 192. In one example, the ground reference 191 is electrically isolated from the ground reference 192.

Thus, on a primary side, the power converter circuit 100 includes a high side switch 121 (S1) and a low side switch 122 (S2), both of which may be represented as transistor switches, coupled in series between terminals of an input voltage source 120 supplying the input voltage Vin to the switch 121.

Accordingly, as shown, the drain node D of the switch 121 receives the input voltage Vin; the source node S of the switch 121 is directly coupled to the drain node D of the switch 122; the source node S of the switch 122 is directly connected to the resistor R1; the resistor R1 is directly connected between the source node of the switch 122 and the ground reference 191.

The shunt resistor R1 may serve as a means for measuring a current flowing on the primary side of power converter 10. The current through the resistor R1 may be measured by controller 140 via an input pin CS of the controller 140, which is coupled directly to a node connecting the low side switch 122 and the shunt resistor R1.

It is further noted that the low side switch 122 is coupled in a closed loop fashion with an inductor Llk (imaginary leakage inductance associated with the primary winding 161), a primary side winding 161 (Lm) of transformer T1 and a resonant capacitor Cr.

A current flowing through inductors Llk, Lm is designated current Ihb. The voltage across the low side switch 122 in the ground reference 191 is generally voltage Vhb. High side switch 121 is controlled by controller 140 via a terminal HSGD outputting respective control signal HSGD to the gate node G of the switch 121. The low side switch 122 is controlled by controller 140 via a terminal LGSD outputting a respective control signal LGSD to the gate node G of the switch 122.

During normal operation, high side switch 121 and low side switch 122 are alternatingly opened and closed in accordance with a resonant frequency defined by the inductance associated with Llk and Lm and the capacitance associated with the resonant capacitor Cr.

Thus, inductors Llk, Lm together with resonant capacitor Cr form a resonant circuit.

In one normal operation of power converter 100, in a first phase in each switching period, the high side switch 121 is closed (a.k.a., ON-state) and low side switch 122 is open (a.k.a., OFF-state), such that energy is transferred from the input voltage source Vin to the resonant circuit including the primary winding 161 and the resonant capacitor Cr. The resonant capacitor Cr is charged.

In a second phase, the resonant capacitor Cr is discharged. For example, the high side switch 121 is open and low side switch 122 is closed in the second phase, causing an energy transfer to a secondary side via transformer T1, such that a secondary current Isec flows through the secondary winding 162 and the diode D1. In this example, the secondary current Isec is rectified using a diode D1 and is filtered by an output capacitor Cout to provide an output current Iout (124) and output voltage Vout to a load 118.

In one example, the diode D1 may represent the diode of a MOSFET of a synchronous rectifier (SR) circuit provided on the secondary side of power converter 100.

Yet further, it is noted that the power converter 100 can be configured to include an auxiliary winding 163 (a.k.a., Laux) disposed on the primary side of the transformer T1. One axial end of the auxiliary winding 163 is directly connected input pin ZCD of the controller 140, while the other axial end of the auxiliary winding 163 is directly connected to the ground reference 191.

Still further, it is noted that during normal operation, a voltage received at terminal ZCD may be used for controlling switches 121 and 122 in a conventional manner, for example to obtain so called zero voltage switching. In other words, the controller 140 can be configured to monitor a condition of 0 current flowing through the primary winding 161 or 0 voltage at the input pin ZCD and control switches 121 and 122 to transition between an on state and an off state or vice versa. More specifically, in one example, based on a voltage at terminal ZCD and/or at voltage at terminal CS of the controller 140, the output voltage 123 or output current 122 may be regulated.

The controller 140 can be configured to receive feedback 175 associated with generation of the output voltage Vout and/or output current Iout from the secondary side (secondary winding 162, diode D1, etc.) of power converter 100, for example via an optocoupler (such as controller 141) bridging the galvanic isolation provided by transformer T1, also in a conventional manner.

Generally, as already mentioned above, operation and regulation during normal operation of the power converter may be performed in any suitable manner.

It is desirable to provide appropriate feedback 175 from the secondary side of the power converter 100 to the controller 140. In general, if the feedback 175 outputted from the controller 141 to the controller 140 indicates that the magnitude of the output voltage 123 is below a setpoint reference voltage 179, the controller 140 controls the switches 121 and 122 to increase an amount of energy supplied to the primary winding 161, resulting in an increase in secondary current Isec (increasing a magnitude of the output voltage 123). Conversely, if the feedback 175 indicates that the magnitude of the output voltage 123 is above a setpoint reference voltage 179, the controller 140 controls the switches 121 and 122 to decrease in amount of energy supplied to the primary winding 161, resulting in a decrease in secondary current Isec (reducing a magnitude of the output voltage 123).

There may be cases where the power converter 100 experiences a so-called exception condition, which may be indicated by the feedback 175 supplied from the controller 141 to the controller 140.

Note that during a so-called exception condition, normal operation of the power converter 100 may be terminated for a variety of reasons. In one example, a condition leading to termination of normal operation is referred to as an exception condition herein. Such an exception condition may include error cases, for example the occurrence of an overvoltage or an overcurrent, as well as an intentional termination of normal operation of the power converter 100 converting the input voltage into the output voltage, for example when a device including the power converter is switched off or put to a power saving mode, where operation of the power converter is not required.

A further example for an exception condition is a separation of the power converter from its input electrical power, which can be either due to a fault condition, for example a blackout or brownout, or also an intentional condition like a user unplugging a device from a mains power socket.

Detection of such exception conditions can be implemented in any suitable manner.

For example, various suitable ways for monitoring the output current or output voltage for overcurrent conditions, short circuit conditions or the like exists, and also the input electrical power may for example be monitored by monitoring an input voltage. Therefore, the detection of the exception condition will not be described in detail. Instead, embodiments described herein will focus on what happens after the exception condition occurs.

Conventionally, during a so-called exception condition, the power converter is merely switched off, for example both high side switch and low side switch of the power converter are set to an off-state. In contrast to conventional techniques, examples herein include novel ways of implementing discharge of the resonant capacitor of the power converter.

Thus, an exception condition may occur when the magnitude of the output voltage 123 is detected as being above a respective setpoint reference voltage 179 and it is necessary for the controller 140 to discontinue activating the high side switch 121, preventing the magnitude of the output voltage 123 from going even higher.

In one example, when an exception condition as occurs, controller 140 terminates normal operation. Unlike conventional power converter controllers and power converters, when terminating the normal operation controller 11 does not simply turn switches S1, S2 off, but controller 140 as discussed herein controls the low side switch S2 to close one or more time periods, while the high side switch 122 remains closed, in order to discharge capacitor Cr. In other words, application of the pulsing of the low side switch 121 on and off to discharge the resonant capacitor Cr. After this discharging, if desired, the low side switch 122 may be switched off, such that power converter 10 is in a switched off state. Alternatively, operation of the power converter 100 may resume where both the switch 121 and the switch 122 are switched on and off again.

As will be explained further below in some more detail, implementation of the discharge techniques may prevent current surges caused by charge stored in resonant capacitor Cr when restarting power converter 100 later. For example, in some instances and implementations power converter 100 may be restarted automatically after the exception condition has occurred when a predefined time period, for example 3 seconds, has elapsed. Such techniques are for example used when the exception condition is an error condition like an overcurrent condition, a drop of the input voltage Vin or a short circuit condition, which may be temporary.

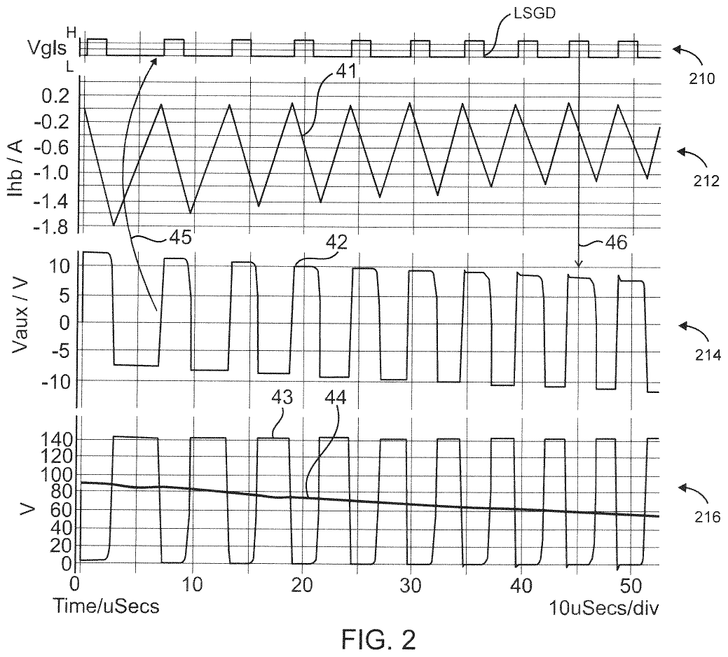

FIG. 2 is an example diagram illustrating generation of control signals in accordance with zero-crossing detection as discussed herein.

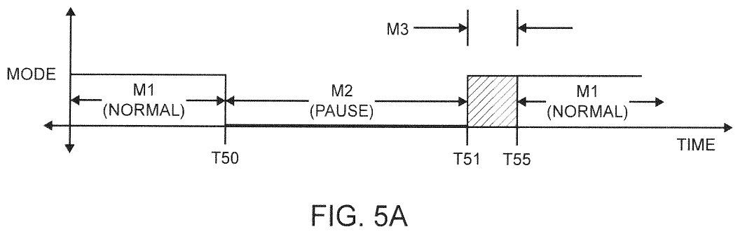

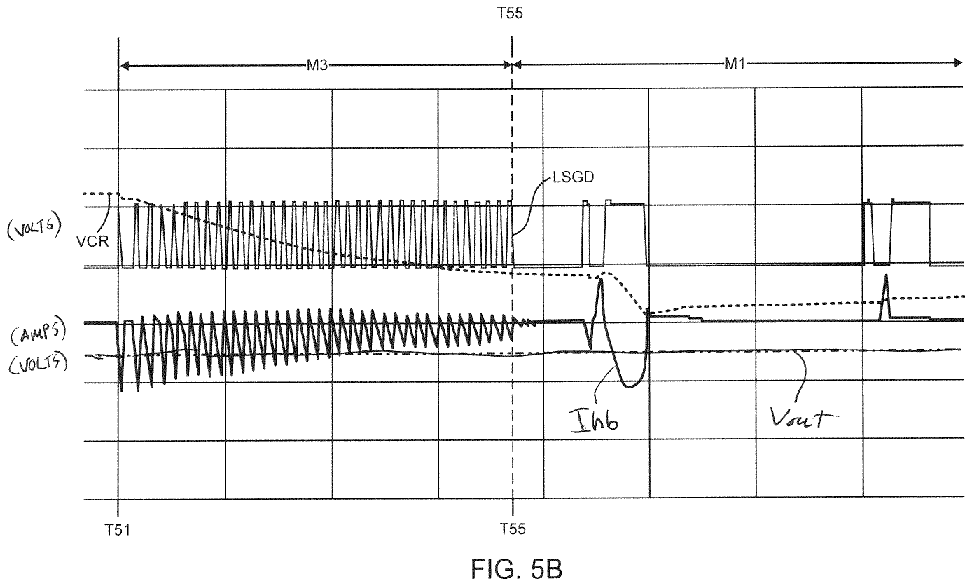

It is noted that the following FIGS. 5, 6, and 8, illustrate operation of the power converter 100 in a mode where the switch 122 is pulsed on and off while the switch 121 is set to an off state. The switching of the switch 122 results in discharge of energy stored in the resonant capacitor Cr through the primary winding to the secondary winding, providing a better synchronization of the voltage in the capacitor Cr and the output voltage 123.

In general, FIG. 2 illustrates operation of the power converter 100 in a mode of discharging the resonant capacitor Cr. The discharge mode is pertinent to the resonant capacitor discharging as discussed in the FIGS. 5, 6, and 8.

A notable aspect associated with the repeated discharge cycles as shown in FIG. 2 is that the controller 140 operating in a so-called zero voltage switching (ZVS) mode to prevent damage to the switches 121 and 122.

Note further that the waveforms as shown in FIG. 2 are presented by way of non-limiting example. Different waveforms may be implemented to achieve the same result.

More specifically, graph 210 illustrates repeated activation of the switch 122 via generation of the control signal LSGD outputted from the controller 140 to the gate node G of the switch 122. A logic high H of the control signal LSGD causes the activation (closed state) of the switch 122 to an ON-state; a logic low L of the control signal LSGD causes deactivation (open) of the switch 122 to an OFF-state.

The curve 41 and graph 212 (timing diagram) illustrates a magnitude of the current Ihb over time; curve 42 in the graph 214 (timing diagram) illustrates an auxiliary voltage Vaux received from auxiliary winding Laux at terminal ZCD; curve 43 in the graph 216 (timing diagram) represents the voltage Vhb across switch S2, and curve 44 and graph 216 represents the voltage across resonant capacitor Cr.

In the example of FIG. 2, the pulses during which low side switch 122 is closed according to curve 40 have a same time duration. When the low side switch is closed, the absolute magnitude of Ihb increases in magnitude in a negative direction, from about 0 to different negative values. When the low side switch 122 is opened, the current Ihb crosses or reaches 0 again.

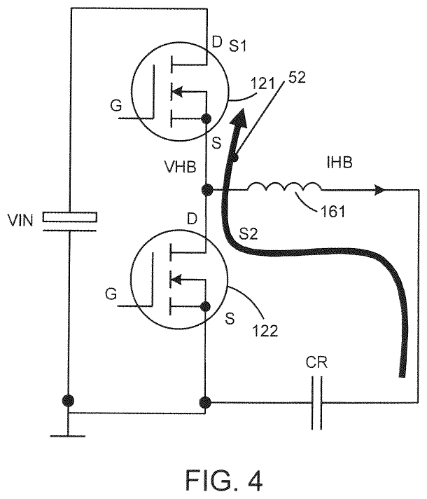

In the example of FIG. 4, a next pulse follows, i.e. low side switch S2 is closed again, when Ihb again has reached a value at or near 0. In some examples, this current Ihb could be directly measured, the voltage across shunt resistor R1. For example, a threshold value may be set in the numerical example of FIG. 4 between 0 and −0.1 volt or, for example, and as soon as this threshold is exceeded, low side switch S2 is closed again. However, in the example shown, the voltage Vaux is used to control switching of the low side switch. As can further be seen in FIG. 4, and as indicated by an arrow 45, curve 42 is essentially synchronous with pulse curve 40, i.e., the voltage Vaux shows a pulse-like behaviour corresponding to the pulses of curve 40. When Vaux goes up again, this indicates a demagnetization of primary winding Lm (and therefore zero current Ihb), at which point the next pulse of curve 40 may follow. Therefore, in some examples the start of the pulses is determined based on Vaux.

Alternatively, a demagnetizing current may be measured at the center point between high side switch 121 and low side switch 122, and regulation may be performed based on this current, e.g. by switching on high side switch 121 again after the demagnetizing current is at zero or differs from zero by no more than a predefined threshold.

Thus, as shown in FIG. 2, as shown by curve 44 (voltage across the resonant capacitor Cr), the repeated pulsing of the switch 122 on and off results in a gradual decrease in the magnitude of the voltage Vcr across the resonant capacitor Cr.

Likewise, as seen from curve 43 (voltage Vhb), the voltage Vhb across low side switch 122 essentially drops to 0 when the low side switch 122 is closed and goes back up to a higher voltage (140 volt in this example) when the switch 122 is open.

As further can be seen, the peak values of Vaux (input to the pin ZCD of the controller 140) according to curve 42 decrease in about the same manner as curve 44 (voltage across the capacitor CR). Therefore, as mentioned above, the auxiliary voltage Vaux received at terminal ZCD of the controller 140 may also serve as a measure of the voltage across the resonant capacitor Cr according to curve 44.

As seen from curve 41, the maximum absolute current over time decreases with increasing discharge of the resonant capacitor Cr. In certain examples, this may be used to increase the duration of the times where the low side switch 122 is closed with decreasing charge of the capacitor, i.e. in contrast to the pulses having equal length of curve 40, the pulses have increasing length.

As indicated by the time arrow 46, for example, the pulse may set depending on the peak voltage of the auxiliary voltage Vaux, such that the time duration increases with decreasing peak voltage of Vaux (and therefore with decreasing charge of the capacitor Cr).

Another examples, the voltage across the capacitor Cr may be measured directly and used for regulation of the pulse length. In yet other examples, the measured magnitude of the negative current Ihb may be used for regulating the pulse duration. In this way, in some examples, a faster discharge may be achieved.

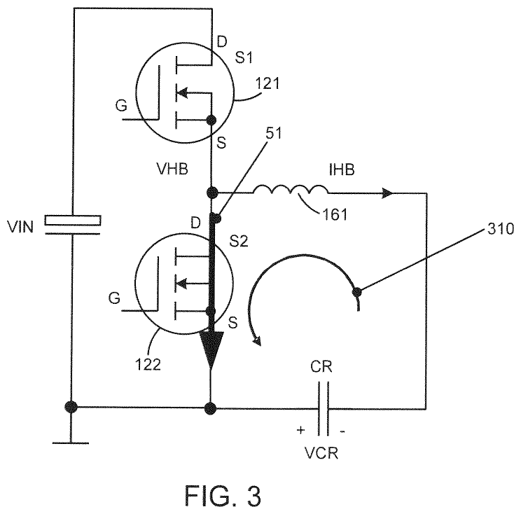

Yet further, it is noted that when discharging the voltage Vcr of the capacitor Cr as illustrated in FIG. 2, in contrast to normal operation of the power converter, the high side switch 121 remains off all the time. Due to this condition, essentially no energy transfer towards the secondary side and the output occurs, but energy stored in the resonant capacitor is transferred back towards the input voltage. This is illustrated in FIGS. 3 and 4, which show parts of power converter 10 of FIG. 1.

FIG. 3 is an example diagram illustrating possible effects associated with operating the power converter as discussed herein.

In general, FIG. 3 shows the current 310 flowing through the combination of switch 122, primary winding 161, and the resonant capacitor Cr when switch S2 is closed (ON-state) based upon the voltage at the gate node S of the switch 122 is in a high state.

FIG. 4 is an example diagram illustrating possible effects associated with operating the power converter as discussed herein.

In general, FIG. 4 shows the situation in the phases where both high side switch 121 and low side switch 122 are both set to an OFF-state, i.e., during the low periods when a magnitude of the control signal applied to the gate node of the switch 121 and the gate node of the switch 122 are both set to a logic low voltage. In such an instance, as indicated by an arrow 52, current from the resonant capacitor Cr flows through the primary winding line 61 and a body diode (a.k.a., and hair diode) of switch 121 towards the input voltage Vin.

FIG. 5A and FIG. 5B are example timing diagrams illustrating implementation of multiple pulses to discharge energy stored in a resonant capacitor as discussed herein.

In this example, the controller 140 operates in different power converter modes M1, M2, and M3, depending upon the state of the feedback signal 175.

During a normal mode M1, prior to time T50, the controller 140 switches between activating the switch 121 and the switch 122 on and off to input current Ihb into the primary winding 161 and charge/discharge the capacitor CR. The controller 140 operates in the normal mode M1 during a condition in which the controller 141 requests, via feedback 175, conveyance of energy from the primary winding to a secondary winding to maintain a magnitude of the output voltage 123 as the load 118 consumes such power provided by the output voltage 123.

In certain instances, the feedback signal 175 indicates to operate in a so-called pause mode in which the controller 140 temporarily discontinues (pauses) inputting energy into the primary winding 161 such as between time T50 and time T51. The controller 140 operates in the so-called pause mode M2 during a condition in which the feedback signal 175 indicates that no energy is needed to be transferred to the secondary winding to produce the output voltage 123.

One example where the feedback signal 175 indicates to operate in the pause mode is a condition in which the load 118 discontinues consumption of power provided by the output voltage 123. In this instance, during the pause mode M2, the controller 140 measures the amount of time of controlling the power converter 100 and corresponding switches 121 and 122 in the pause mode between time T50 in time T51. In the pause mode M2, the controller continuously deactivates the switches 121 and 122. As previously discussed, the discontinued activation of the switches stops a flow of energy from the primary winding 161 to the secondary winding 162.

Eventually, at or around time T51, assume that the feedback signal 175 indicates to switch over to the normal operational mode M1 again because the load 118 continues to consume power provided by the output voltage. However, before operating in the mode M1 again in this example, the controller 140 operates in the mode M3 to discharge the voltage Vcr across the resonant capacitor Cr to align/synchronize voltages. More specifically, in one example, the purpose of operating in the mode M3 between time T51 and time T55 prior to operating in mode M1 again is to ensure voltage synchronization/alignment of the voltage Vcr across the capacitor Cr and the output voltage 123 across the capacitor Cout. The synchronization as discussed herein reduces stress on the switch 122 and the switch 121 when the switches 121/122 are further switched in the normal operational mode M1 again at or around time T55 and thereafter.

In one example, in the mode M3, the controller 140 pulses the switch 122 (while the switch 121 is deactivated to an OFF-state) for a number of times or for a duration of time which depends on the duration of the previous converter switching measured pause time (between time T50 and time T51), where the so-called switching pause time corresponds to a condition in which the feedback 175 indicates to discontinue providing energy into the primary winding 161.

In one proposed example solution, as previously discussed, the controller 140 can be configured to measure the converter pause time (time duration associated with operation in mode 2) as dictated by the feedback signal 175 (such as voltage Vfb inputted to the controller 140), where the feedback signal 175 indicates the required converter operation (i.e., switching in and out of pause mode), the controller 140 initiates execution of an appropriate number of times (pulses) of activating and deactivating (pulsing on and off) the switch 122 in mode M3 (while the switch 121 is always off) to discharge the capacitor Cr prior to operating in the normal mode M1 again.

As shown in FIG. 5B, the number of pulses of activating the switch 122 in the mode M3 before resuming normal operation (switching between activating the switch 121 and activating the switch 122 to convey energy from the input voltage to the primary winding and secondary winding) depends on the converter previous pause time duration as measured between time T50 and time T51. Again, the pause duration occurs in response to a condition in which the feedback signal 175 indicates to the controller 140 to discontinue supplying energy to the primary winding 161.

Accordingly, the controller 140 as discussed herein can be configured to measure the pause duration of operating in the mode M2 and use such time duration information as a basis to control how many times the low side switch 122 is pulsed on and off (in mode M3 between time T51 and time T55) prior to executing operation of the power converter 100 in the normal mode M1 again such as after time T55.

As previously discussed, the normal mode M1 includes the load 118 consuming energy supplied by the output voltage 123, which is supplied by energy received from the secondary winding 162. Assume that the load 118 discontinues consumption of the energy provided by the output voltage 123 at or around time T50. In such an instance, the controller 141 produces the feedback signal 175 to indicate this so-called pause condition of operating in the mode M2. The controller 140 of the power converter 100 temporarily deactivates both the switch 121 and the switch 122 during this pause condition.

As a further example, assume that the controller 140 measures a pause condition of operating in mode M2 for 305 milliseconds (mS). In such an instance, assuming that the conversion of pause time to low side activation pulses is one pulse for each 20 milliseconds of pause time in mode M2, during the mode M3, the controller 140 generates 15 pulses that are applied to the switch 122 prior to operating the power converter in the normal mode again (i.e., 305 ms sleep/pause=>305/20~=15 pulses of activating the switch 122 on and off while the switch 121 is set to an off state).

This controlled pulsing of the low side switch 122 during mode M3 causes a discharge of energy in the capacitor Cr, which results in a flow of current Ihb through the primary winding 161 based upon the energy discharge from the capacitor Cr. The energy discharge of the capacitor Cr by switching the switch 122 during the mode M3 causes the magnitude of the voltage across the resonant capacitor Cr to decrease and become more aligned or synchronized with respect to the magnitude of the output voltage 123.

As another example, assume that the controller 140 measures a pause condition of operating in mode M2 for 440 milliseconds (mS). In such an instance, assuming that the conversion of pause time to pulses is one pulse for each 20 milliseconds, during the mode M3, the controller 140 generates 22 pulses that are subsequently applied to the switch 122 prior to operating the power converter in the normal mode again (i.e. 440 ms sleep=>440~=22 pulses of activating the switch 122 on and off while the switch 121 is set to an off state.)

This controlled pulsing of the low side switch 122 during mode M3 causes a discharge of energy in the capacitor Cr, which results in a flow of current Ihb through the primary winding 161 based upon the energy discharge of the voltage Vcr and corresponding energy stored in the capacitor Cr. The energy discharge of the capacitor Cr causes the magnitude of the voltage Vcr across the resonant capacitor Cr to decrease and become more aligned with the magnitude of the output voltage 123.

Thus, in one example as shown in FIGS. 5A and 5B as well as other FIGS. herein, an apparatus (such as a resonant power converter, hybrid flyback converter, etc.) or other suitable entity includes a controller 140. The controller 140 can be configured to (a.k.a., operative to): control ON/OFF settings of multiple switches 121/122 in a resonant power converter 100 during a first operational mode (normal or M1) to convert an input voltage 121 into an output voltage 123; in response to first feedback 175, implement a second operational mode M2 (such as a so-called pause mode) of discontinued switching of the multiple switches ON and OFF; and based on a time duration associated with operation of the resonant power converter in the pause mode (M2), control the multiple switches in the resonant power converter in a third mode M3 to discharge a resonant capacitor Cr of the resonant power converter 100 prior to operating in the normal mode M1 again.

As previously discussed, the control of the multiple switches 122/122 to discharge the resonant capacitor Cr during the third mode M3 includes continuing to control the switch 121 to be in an off state between time T51 and time T55, while the switch 122 is pulsed on and off between time T51 and time T55.

In a further example, the time duration between time T50 and time T51 is a measurement of the implemented second operational mode M2 (possible) of discontinued switching of the multiple switches 121/122 as controlled by the feedback 175.

In another example, it is noted again that the multiple switches 121/122 in the resonant power converter 100 are disposed in series; and the controller 140 is further configured to: derive a metric (such as a time duration value, control value, etc.) for controlling the switch 122 based on the time duration. The metric such as a control value may indicate timing associated with activating the switch 122 to discharge the resonant capacitor Cr of the resonant power converter.

For example, as previously discussed, the metric may be generated by the controller 140 and further may indicate a number of pulses or time duration of activating the switch 122 to cause the discharge of the resonant capacitor while in the temporary mode M3 (resonant capacitor discharge mode). As previously discussed, the magnitude of the metric (controlled time duration in mode M3) for controlling the switch 122 may be proportional to a magnitude of the measured time duration associated with operation in the mode M2 between time T50 and time T51.

Accordingly, in one example, the controller 140 is configured to: control the multiple switches 121/122 in the resonant power converter to discharge the resonant capacitor Cr in response to receiving second feedback (such as feedback 175 during the mode M2), where the second feedback indicates that the magnitude of the output voltage 123 is greater than a setpoint reference voltage. In other words, the second feedback 175 may indicate to operate in the mode M2 based on the magnitude of the output voltage 123 being greater than a setpoint reference voltage 179.

As previously discussed, other conditions can cause the power converter 100 to operate in the pause mode (mode M2). For example, the setpoint reference voltage 179 may be changed from 100 volts to 50 volts. This condition may cause the feedback signal to indicate to operate the primary side of the power converter 100 and the pause mode.

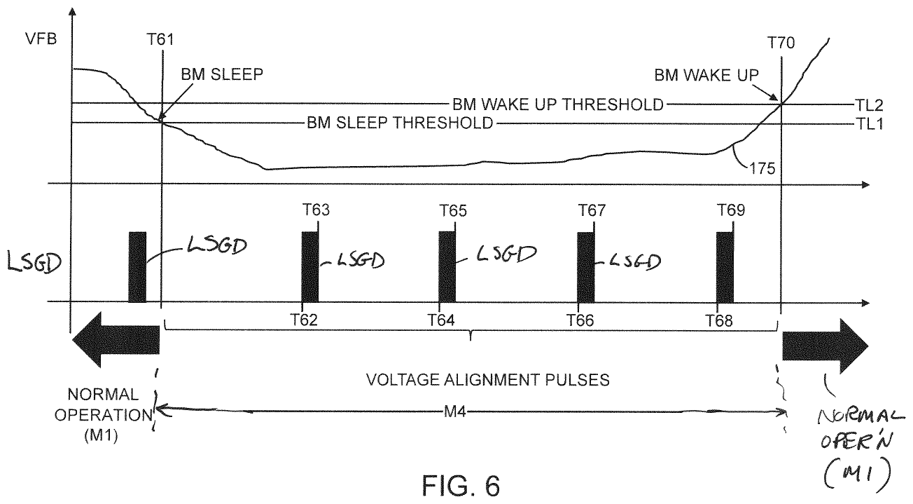

FIG. 6 is an example timing diagram illustrating implementation of multiple switch pulses to discharge energy stored in a resonant capacitor as discussed herein.

As previously discussed, the feedback signal 175 can be configured to indicate to operate the primary side of the power converter 108 in a so-called pause mode or quasi-pause mode such as M4 between time T61 and time T70.

In this example, during the request for pause between time T61 and time T70 and corresponding operation in the mode M4 as indicated by the feedback 175, the controller 140 occasionally pulses the switch 122 on and off while the switch 121 is set to an off state to ensure the voltage alignment/synchronization of the voltage Vcr across the resonant capacitor Cr and the output voltage 123 across the output capacitor Cout.

Accordingly, techniques herein include the controller 140 regularly generating low side switch pulses to control switch 122 such as on-off control signal pulses (LSGD) applied to the gate node of the switch 122 during a so-called BM sleep mode M4 (pause mode or quasi-pause mode) to ensure voltage synchronization/aligment of Cr and Cout. In this example, the controller 140 detects a start time of the so-called pause mode or sleep mode M4 in response to detecting that the feedback signal 175 falls below the threshold level TL1 at or around time T61.

In response to detecting operation in the sleep mode M4 at or around time T61, the controller 140 produces the on-off control pulses LSGD (such as one or more pulses similar to the pulses and timing as shown in FIG. 2 applied to the gate node of the switch 122) starting at time T62 (such as one or more on-off control pulses) and ending at time T63; the controller 140 generates the on-off control pulses LSGD applied to the switch 122 starting at time T64 (such as one or more on-off control pulses) and ending at time T65; the controller 140 generates the on-off control pulses LSGD applied to the switch 122 starting at time T66 (such as one or more on-off control pulses) and ending at time T67; the controller 140 generates the on-off control pulses LSGD applied to the switch 122 starting at time T68 (such as one or more on-off control pulses) and ending at time T69. At or around time T70, the controller 140 detects that the magnitude of the feedback signal 175 is greater than the threshold level TL2.

In response to detecting this condition at time T70, the controller 140 switches back to operating the power converter 100 in the normal operational mode M1, where the controller 140 repeatedly switches between activating the switch 121 and deactivating the switch 122 for a first time duration followed by the controller deactivating the switch 121 and activating the switch 122 for a second time duration. This on-off controlling of the switches 121 and 122 in the normal mode M1 again results in conveyance of energy from the primary winding 161 to the secondary winding 162, and maintaining a magnitude of the output voltage 123 to a desired level as controlled based on the feedback 175.

In one example, the greater the magnitude of the feedback signal 175 above the threshold level TL2, the longer the overall percentage of time or duty cycle that the controller 140 activates the switch 121 during the on-off switching. Thus, the feedback signal 175 can be configured to indicate an error associated with output voltage 123 with respect to the setpoint reference voltage 179. That is, when the feedback signal 175 indicates that the magnitude of the output voltage 123 is greater than the setpoint reference voltage 179, the feedback signal 175 controls the controller 140 to operate in the mode M4 (pause mode or quasi-pause mode). Conversely, when the feedback signal 175 indicates that the magnitude of the output voltage 123 is less than the setpoint reference voltage 179, the feedback signal 175 notifies the controller 140 to operate in the mode M1 again.

Thus, in this example, an apparatus (such as a resonant power converter, hybrid flyback converter, etc.) or other suitable entity includes a controller. The controller can be configured to (a.k.a., operative to): control multiple switches 121 and 122 in a resonant power converter 100 during a first operational mode M1 to convert an input voltage Vin into an output voltage 123; in response to first feedback 175, implement operational mode M4 of controlling the multiple switches, where the multiple switches include switch 121 and switch 122; and during the operational mode M4, control the switch 121 to an OFF state while controlling operation of the switch 122 between an OFF state and an ON state to discharge a resonant capacitor Cr of the resonant power converter 100.

In one example, the feedback 175 indicates that the magnitude of the output voltage 123 is greater than a threshold level (feedback signal 175 is less than the threshold level TL1). The controller 140 can be further configured to, subsequent to the operational mode M4 between time T61 and time T70, resume operation of the resonant power converter in the operational mode M1 again in response to receiving feedback signal 175 being greater than the threshold level TL2 (indicating that the output voltage 123 is less than a threshold level (such as a setpoint reference voltage) at time T70. In such an instance, in response to transitioning to the wake up state and corresponding operational mode M1, the controller 140 configured to switches over operation of the resonant power converter 100 from the operational mode M4 to the operational mode M1.

In another example, the controller 140 can be configured to switch over operation of the resonant power converter 100 from the operational mode M4 to the operational mode M1 in response to detecting that a magnitude of the output voltage 123 is less than the setpoint reference voltage 179 as indicated by the magnitude of the feedback signal 175 being greater than the threshold level TL2.

In another example, operation of the resonant power converter 100 in the operational mode M4 between time T61 and time T70 in the operational mode M4 advantageously maintains a magnitude of a voltage Vcr across the resonant capacitor Cr with respect to a magnitude of the output voltage 123.

Still further, in another example, the controller 140 can be configured to, subsequent to the operational mode M4 between time T61 and time T70, resume the operational mode M1 of switching the multiple switches between the ON/OFF states to convert the input voltage into the output voltage.

As previously discussed, the multiple switches associated with the power converter 100 can be configured to switch 121 and switch 122 disposed in a first series circuit path, where the first series circuit path is configured to control conveyance of current Ihb through the primary winding 161 of the transformer T1. In a second series circuit path, the primary winding 161 is disposed in series with the resonant capacitor Cr. The second series circuit path such as the capacitor Cr in the primary winding 161 are disposed in parallel with the switch 122. Flow of current Ihb through the primary winding 161 causes a respective flow of current Isec through the secondary winding 162, where the flow of current through the secondary winding produces the output voltage 123 to power the load 118.

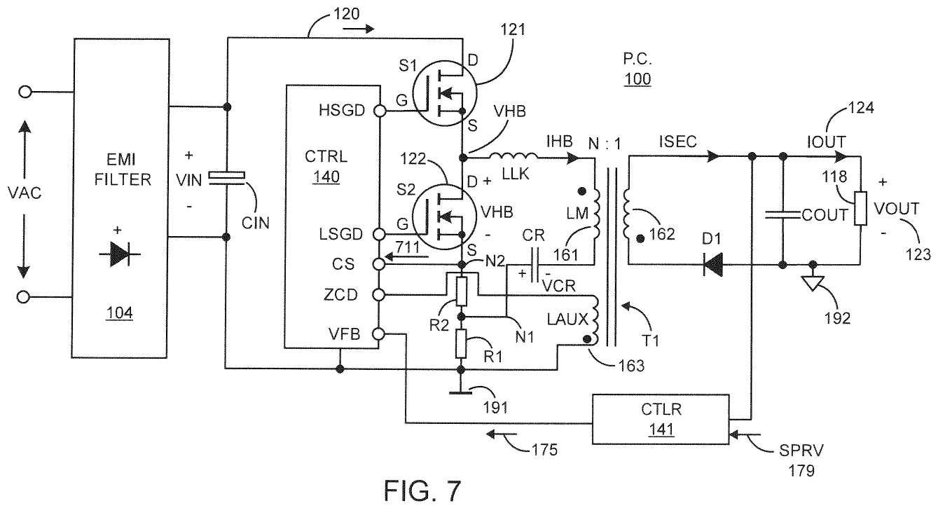

FIG. 7 is an example circuit diagram illustrating a supplemental resistor to monitor the magnitude of current through a resonant capacitor and winding as discussed.

In this example, the power converter 100 includes the resistor R2 disposed between the source node (node N2) of the switch 122 and the node N1. In such an instance, the controller 140 monitors a magnitude of the voltage at the node N2 (voltage across the resistor R2), which indicates a magnitude of the current Ihb through the primary winding 161 and the capacitor Cr. For example, the magnitude of the current Ihb is measured based upon dividing a voltage at the node N2 (voltage across the resistor R2) by a magnitude of the resistance associated with the resistor R2.

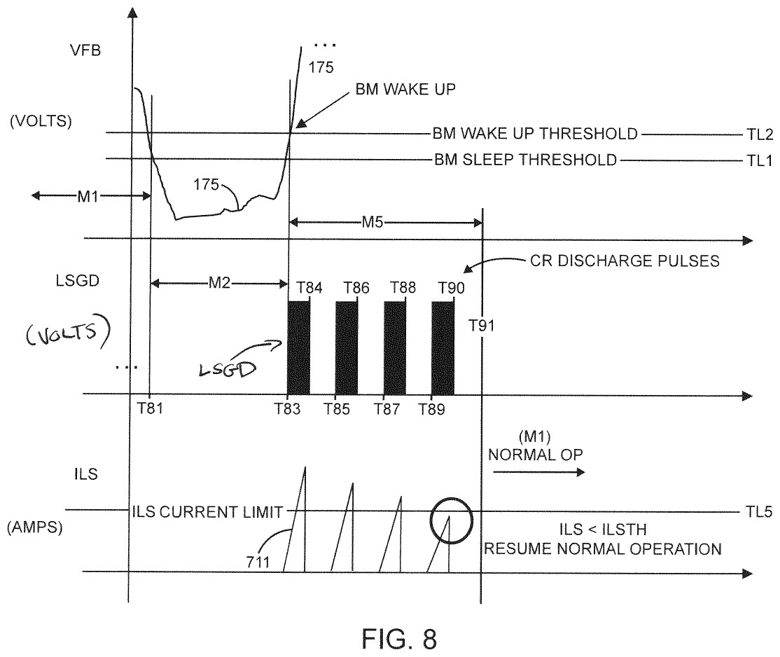

FIG. 8 is an example diagram illustrating implementation of multiple switch pulses to discharge energy stored in a resonant capacitor as discussed herein.

In this example, using the circuit as shown in FIG. 7, prior to time T81, the controller 140 operates the power converter 100 and corresponding switches 121 and 122 in the mode M1 as previously discussed. In response to detecting that the feedback signal 175 falls below the threshold level TL1, the controller 140 switches to operation in the mode M2, where the controller 140 deactivates both of the switches 121 and 122 between the time T81 and the time T83.

The controller 140 continues to monitor the feedback signal 175 between time T81 and time T83. At time T83, the controller 140 detects that the feedback signal 175 is greater than the threshold level TL2. In such an instance, the controller 140 transitions control of the switches 121 and 122 in the power converter 100 in accordance with the normal operational mode M1 again. In order to synchronize/align a magnitude of the voltage Vcr across the resonant capacitor Cr and a magnitude of the output voltage 123, prior to implementing the normal operational mode M1 again, the controller 140 implements the operational mode M5. As shown in. 8, implementation of the operational mode M5 includes the controller deactivating the switch 121 for a full duration between time T81 and time T91.

During the mode M5 starting at time T83, the controller 140 applies one or more on off control pulses to the gate node of the switch 122 at or around time T83 up until around time T84. An example of switching is again shown in FIG. 2. The application of these one or more control pulses to the switch 122 starting at or around time T83 up until around time T84 causes a magnitude of the current iLS through the resistor R2 and corresponding switch 122 to ramp up above the current threshold level TL5. Because the magnitude of the current iLS through the resistor R2 and the corresponding switch 122 is greater than the threshold level TL5 at or around time T84, the controller 140 continues operation in the mode M5.

Between time T84 and time T85, the controller 140 controls both the switch 121 and the switch 122 to be in an off state.

Starting at time T85, the controller 140 applies one or more on off control pulses to the gate node of the switch 122 at or around time T85 up until around time T86. The application of these one or more control pulses starting at or around time T85 up until around time T86 causes a magnitude of the current iLS through the resistor R2 and corresponding switch 122 to ramp up above the current threshold level TL5. Because the magnitude of the current iLS through the resistor R2 and the corresponding switch 122 is greater than the threshold level TL5 at or around time T86, the controller 140 continues operation in the mode M5.

Between time T86 and time T87, the controller 140 controls both the switch 121 and the switch 122 to be in an off state.

Starting at time T87, the controller 140 applies one or more on off control pulses to the gate node of the switch 122 at or around time T87 up until around time T88. The application of these one or more control pulses starting at or around time T87 up until around time T88 causes a peak magnitude of the current iLS through the resistor R2 and corresponding switch 122 to ramp up above the current threshold level TL5. Because the magnitude of the current iLS through the resistor R2 and the corresponding switch 122 is greater than the threshold level TL5 at or around time T88, the controller 140 continues operation in the mode M5.

Between time T88 and time T89, the controller 140 controls both the switch 121 and the switch 122 to be in an off state.

Starting at time T89, the controller 140 applies one or more on off control pulses to the gate node of the switch 122 at or around time T89 up until around time T90. The application of these one or more control pulses starting at or around time T89 up until around time T90 causes a peak magnitude of the current iLS through the resistor R2 and corresponding switch 122 to ramp up only to a magnitude below the current threshold level TL5. Because the magnitude of the current iLS through the resistor R2 and the corresponding switch 122 is less than the threshold level TL5 at or around time T90, the controller 140 switches over to operation from the mode M5 to the mode M1 at or around time T90 or time T91. Thus, at or around time T90, in response to the controller 140 detecting that the peak magnitude of the voltage 711 is less than the threshold level TL5 at time T89, the controller 140 detects that the capacitor Cr is sufficiently discharged below a threshold level such that the voltage across the capacitor Cr is aligned/synchronize with the output voltage 123, enabling resumption of the normal operational mode M1 sometime after time T89.

Thus, examples herein include, upon resumption of switching from mode M2 to the mode M1 again, the controller 140 operates in mode M5 during which the controller 140 pulses the switch 122 on and off (while the switch 121 is set to an off state) as long as a peak magnitude of the current Ihb as observed from monitoring the voltage 711 across resistor R2 is above a given current threshold TL5.

Thus, in this example, an apparatus (such as a resonant power converter, hybrid flyback converter, etc.) or other suitable entity includes a controller. The controller can be configured to: control multiple switches in a resonant power converter between ON/OFF states during a first operational mode M1 to convert an input voltage into an output voltage 123; and in response to first feedback 175, implement a second operational mode M2 of discontinued switching of the multiple switches ON and OFF; and based on a magnitude of current through a switch 122 of the multiple switches, control the switch 122 of the multiple switches to discharge the voltage Vcr across the resonant capacitor Cr of the resonant power converter.

As previously discussed, the switch 122 may be disposed in a series circuit loop; the series circuit loop can be configured to include a combination of the switch 122, a primary winding 161 of a transformer T1, and the resonant capacitor Cr.

In another example, as previously discussed, the controller 140 can be configured to, subsequent to implementing the operational mode M2, control the switch 122 to discharge the resonant capacitor Cr prior to resuming the operational mode M1 of switching the multiple switches between the ON/OFF states.

Still further, as previously discussed, examples herein include the controller being configured to: while a switch 121 of the multiple switches is deactivated to an OFF-state: monitor a magnitude of the current Ihb through the switch 122; compare the magnitude of current Ihb to a current threshold level TL5; and switch the switch 121 between an ON-state and an OFF-state until the magnitude of the peak current Ihb through the switch 121 falls below the current threshold level TL5. The controller 140 can be configured to resume the first operational mode M1 of switching the multiple switches ON and OFF in response to detecting that the magnitude of the peak current Ihb crosses (such as drops below) the current threshold level TL5.

Yet further examples herein include a controller configured to: control the switch 122 of the multiple switches to discharge the resonant capacitor Cr in order to transition from the mode M2 to the mode M1 (with operation in the mode M5 in between) in response to receiving second feedback signal 175 (magnitude of feedback signal is greater than the threshold level TL2) indicating that the magnitude of the output voltage 123 falls below a voltage threshold level.

Further, as previously discussed, the monitored magnitude of current Ihb may be a peak magnitude of the current Ihb through the switch 122.

In another example, the magnitude of the current Ihb may be measured based upon a voltage across a resistor R2 disposed in series with the resonant capacitor Cr, wherein the voltage across the capacitor Cr is proportional to the magnitude of the current Ihb.

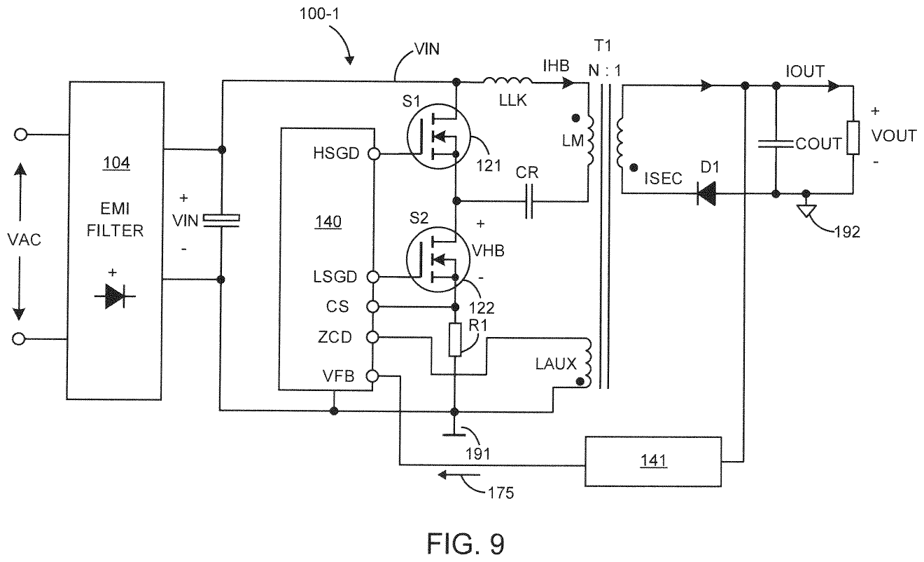

FIG. 9 is an example diagram illustrating implementation of a resonant power converter as discussed herein.

As previously discussed, the power converter 100 as discussed herein can be implemented in any suitable manner.

In one example, the resonant tank formed by the primary winding 161 and the capacitor Cr may be implemented as a loop of circuitry including the switch 121 instead of the switch 122 as previously discussed. Accordingly, the resonant tank formed by the transformer T1 and the resonant capacitor Cr may be connected to the input voltage Vin, where the operation of the switch 121 and switch 122 is reversed.

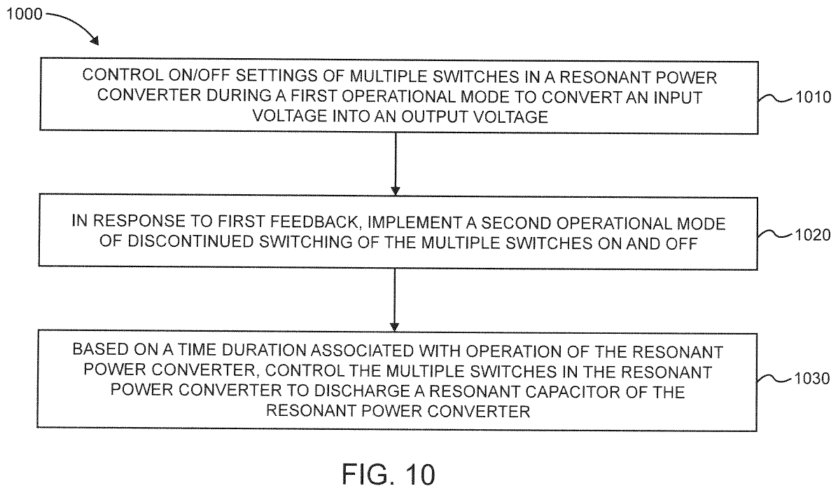

FIG. 10 is an example diagram illustrating a first method of implementing multiple switch pulses to discharge energy stored in a resonant capacitor as discussed herein.

In processing operation 1010 a flowchart 1000, a controller controls ON/OFF settings of multiple switches in a resonant power converter during a first operational mode to convert an input voltage into an output voltage.

In processing operation 1020, in response to first feedback, the controller implements a second operational mode of discontinued switching of the multiple switches ON and OFF.

In processing operation 1030, based on a time duration associated with operation of the resonant power converter in the second operational mode, the controller controls the multiple switches in the resonant power converter to discharge a resonant capacitor of the resonant power converter.

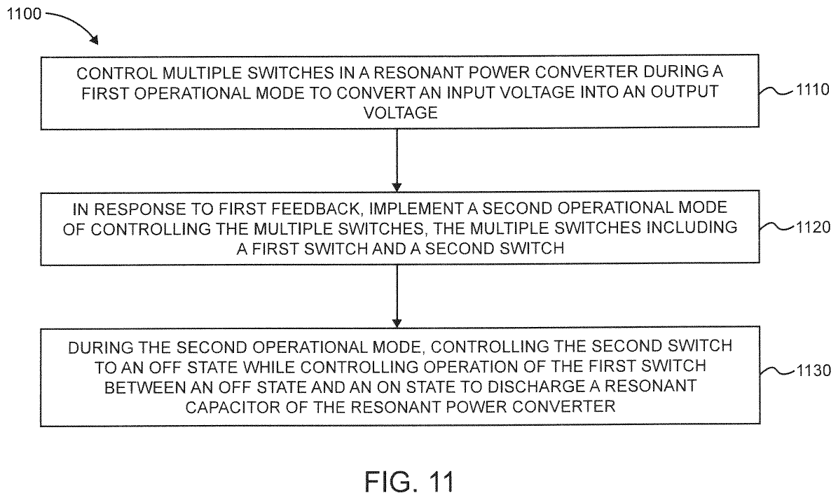

FIG. 11 is an example diagram illustrating a second method of implementing multiple switch pulses to discharge energy stored in a resonant capacitor as discussed herein.

In processing operation 1110 of flowchart 1100, a controller controls multiple switches in a resonant power converter during a first operational mode to convert an input voltage into an output voltage.

In processing operation 1120, in response to first feedback indicating to discontinue execution of the resonant power converter in the first operational mode, the controller implements a second operational mode of controlling the multiple switches, the multiple switches including a first switch and a second switch.

In processing operation 1130, during the second operational mode, the controller controls the second switch to an OFF state while controlling operation of the first switch between an OFF state and an ON state to discharge a resonant capacitor of the resonant power converter.

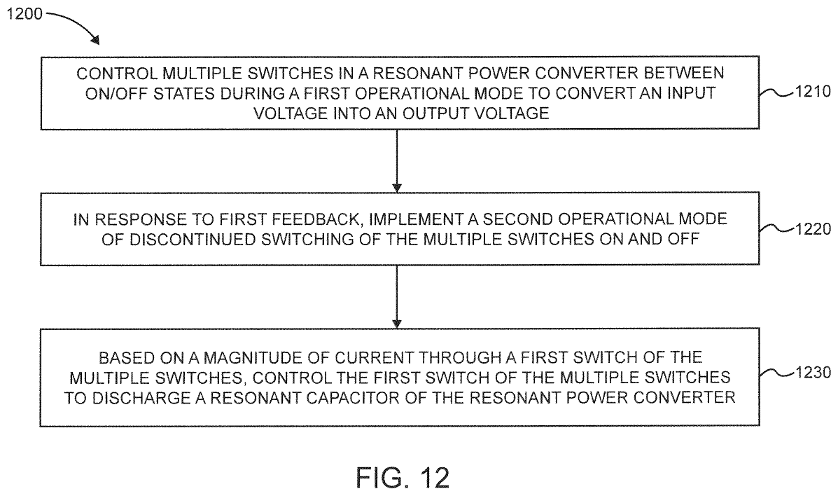

FIG. 12 is an example diagram illustrating a third method of implementing multiple switch pulses to discharge energy stored in a resonant capacitor as discussed herein.

In processing operation 1210 of flowchart 1200, a controller controls multiple switches in a resonant power converter between ON/OFF states during a first operational mode to convert an input voltage into an output voltage.

In processing operation 1220, in response to first feedback, the controller implements a second operational mode of discontinued switching of the multiple switches ON and OFF.

In processing operation 1230, based on a magnitude of current through a first switch of the multiple switches, the controller controls the first switch of the multiple switches to discharge a resonant capacitor of the resonant power converter.

Note again that techniques herein are well suited for use in power converters such as those implementing a resonant capacitor to support conversion of an input voltage into an output voltage. However, it should be noted that techniques herein are not limited to use in such applications and that the techniques discussed herein are well suited for other applications as well.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

1. An apparatus comprising:
a controller operative to:
control ON/OFF settings of multiple switches in a resonant power converter during a first operational mode to convert an input voltage into an output voltage;
in response to first feedback, implement a second operational mode of discontinued switching of the multiple switches ON and OFF; and
based on a time duration associated with operation of the resonant power converter in the second operational mode, control the multiple switches in the resonant power converter to discharge a resonant capacitor of the resonant power converter.

2. The apparatus as in claim 1, wherein the time duration is a measurement of the implemented second operational mode of discontinued switching of the multiple switches.

3. The apparatus as in claim 1, wherein the multiple switches in the resonant power converter include a first switch and a second switch disposed in series; and
wherein the controller is further operative to: derive a metric for controlling the first switch based on the time duration.

4. The apparatus as in claim 3, wherein a magnitude of the metric for controlling the first switch is proportional to a magnitude of the time duration.

5. The apparatus as in claim 3, wherein the metric indicates a number of pulses of activating the first switch to cause the discharge of the resonant capacitor.

6. The apparatus as in claim 3, wherein the metric indicates timing attributes associated with activating the first switch to discharge the resonant capacitor of the resonant power converter.

7. The apparatus as in claim 1, wherein the multiple switches include a first switch and a second switch, the first switch disposed in series with the resonant capacitor; and
wherein the controller is further operative to: while the second switch is controlled to an OFF-state during the discharge of the resonant capacitor, in accordance with the time duration, control switching operation of the first switch to discharge the resonant capacitor prior to controlling the power converter in the first operational mode again.

8. The apparatus as in claim 1, wherein the controller is further operative to:
measure the time duration of the discontinued switching of the multiple switches while in the second operational mode;
based on the measured time duration, control timing of activating and deactivating a first switch of the multiple switches to discharge the resonant capacitor in the second operational mode; and
wherein a cumulative ON-time associated with the controlled timing of the first switch to discharge the resonant capacitor is based on the measured time duration.

9. The apparatus as in claim 1, wherein the multiple switches include a first switch and a second switch disposed in a first series circuit path, the first series circuit path of multiple switches operative to control conveyance of current received from the input voltage to the resonant capacitor;
wherein the resonant power converter further includes a primary winding disposed in series with the resonant capacitor in a second series circuit path;
wherein the second series circuit path is disposed in parallel with the second switch; and
wherein the primary winding is magnetically coupled to a secondary winding operative to produce the output voltage.

10. The apparatus as in claim 1, wherein the controller is further operative to:
control the multiple switches in the resonant power converter to discharge the resonant capacitor in response to receiving second feedback, the second feedback indicating that the magnitude of the output voltage is less than a setpoint reference voltage.

11. An apparatus comprising:
a controller operative to:
control multiple switches in a resonant power converter during a first operational mode to convert an input voltage into an output voltage;
in response to first feedback indicating to discontinue execution of the resonant power converter in the first operational mode, implement a second operational mode of controlling the multiple switches, the multiple switches including a first switch and a second switch; and
during the second operational mode, controlling the second switch to an OFF state while controlling operation of the first switch between an OFF state and an ON state to discharge a resonant capacitor of the resonant power converter.

12-14. (canceled)

15. The apparatus as in claim 11, wherein operation of the resonant power converter in the second operational mode is operative to maintain a magnitude of a first voltage across the resonant capacitor with respect to a magnitude of the output voltage.

16. (canceled)

17. The apparatus as in claim 11, wherein the multiple switches include the first switch and a second switch disposed in a first series circuit path, the first series circuit path operative to control conveyance of current received from an input voltage;
wherein the resonant power converter further includes a primary winding disposed in series with the resonant capacitor in a second series circuit path;
wherein the second series circuit path is disposed in parallel with the second switch; and
wherein the primary winding is magnetically coupled to a secondary winding operative to produce the output voltage.

18. An apparatus comprising:
a controller operative to:
control multiple switches in a resonant power converter between ON/OFF states during a first operational mode to convert an input voltage into an output voltage;
in response to first feedback, implement a second operational mode of discontinued switching of the multiple switches ON and OFF; and
based on a magnitude of current through a first switch of the multiple switches, control the first switch of the multiple switches to discharge a resonant capacitor of the resonant power converter.

19. (canceled)

20. The apparatus as in claim 18, wherein the controller is operative to, subsequent to the second operational mode, control the first switch to discharge the resonant capacitor prior to resuming the first operational mode of switching the multiple switches between the ON/OFF states.

21. The apparatus as in claim 18, wherein the multiple switches include a second switch, the first switch disposed in series with the second switch; and
wherein the control of the first switch to discharge the resonant capacitor is implemented by the controller in a third operational mode, which includes deactivation of the second switch to an OFF-state while the first switch is switched between an ON-state and an OFF-state prior to switching over to execution of the resonant power converter in the first operational mode again.

22. The apparatus as in claim 18, wherein the controller is further operative to:
while a second switch of the multiple switches is deactivated to an OFF-state in a third operational mode of discharging the resonant capacitor based on the magnitude of the current:
monitor a magnitude of the current through the first switch;
compare the magnitude of current to a current threshold level; and
switch the first switch between an ON-state and an OFF-state until the magnitude of the current through the first switch falls below the current threshold level.

23. The apparatus as in claim 22, wherein the controller is further operative to:
resume the first operational mode of switching the multiple switches ON and OFF in response to detecting that the magnitude of the current crosses the current threshold level.

24. The apparatus as in claim 18, wherein the controller is further operative to:
control the first switch of the multiple switches to discharge the resonant capacitor in response to receiving second feedback indicating that the magnitude of the output voltage falls below a voltage threshold level.

25. The apparatus as in claim 18, wherein the multiple switches include the first switch and a second switch disposed in a first series circuit path, the first series circuit path operative to control conveyance of current received from an input voltage;
wherein the resonant power converter further includes a primary winding disposed in series with the resonant capacitor in a second series circuit path;
wherein the second series circuit path is disposed in parallel with the second switch; and
wherein the primary winding is magnetically coupled to a secondary winding operative to produce the output voltage.

26-27. (canceled)
